(19) United States
(12) Patent Application Publication
(10) Pub. No.: US 2014/0043311 A1
(43) Pub. Date: Feb. 13, 2014

(54) Liquid Crystal Display Driving Circuit, Driving Method Thereof And Liquid Crystal Display

(71) Applicant: BOE Technology Group Co., Ltd., Beijing (CN)

(72) Inventors: Jiyang Shao, Beijing (CN); Chulgyu Jung, Beijing (CN); Shou Li, Beijing (CN)

(73) Assignee: BOE Technology Group Co., Ltd., Beijing (CN)

(21) Appl. No.: 13/962,277

(22) Filed: Aug. 8, 2013

(30) Foreign Application Priority Data
Aug. 9, 2012 (CN) 201210283471.9

(51) Int. Cl. G09G 3/36

(52) U.S. Cl. CPC G09G 3/3614
USPC 345/209; 345/96

(57) ABSTRACT

Embodiments of the present disclosure provide a liquid crystal display driving circuit, a driving method thereof and a liquid crystal display, and relate to a field of display technique. The liquid crystal display driving circuit comprises a timing control circuit and at least two source driving circuits, and further comprises a polarity inversion circuit; the timing control circuit is configured to transmit a polarity inversion signal to the polarity inversion circuit; the polarity inversion circuit is configured to convert the polarity inversion signal into a first polarity inversion signal and a second polarity inversion signal which are output to the at least two source driving circuits, respectively, so that voltages of source signals driven by the at least two source driving circuits have opposite polarities with each other; wherein a phase of the first polarity inversion signal is different from that of the second polarity inversion signal.

### TECHNICAL FIELD

The present disclosure relates to a field of display technique, and particularly to a liquid crystal display driving circuit, a driving method thereof and a liquid crystal display.

### BACKGROUND

A liquid crystal display displays a picture by adjusting transmittance of lights of red, green and blue sub-pixels in each pixel. The liquid crystal display provides data to pixel electrodes through a source driving circuit during a scan period, and holds the data on the pixel electrodes during a frame period so as to drive liquid crystal molecules to deflect, thus an image is displayed. In order to improve a display quality of a liquid crystal panel and avoid a polarization nonuniformity of the liquid crystal, the pixel electrode is required to be driven by an Alternating Current (AC) voltage, that is, polarities of data voltages on the pixel electrodes should be subject to an inversion satisfying a certain regularity periodically.

Existing polarity inversion method comprises a frame polarity inversion, a linear polarity inversion, a point polarity inversion, etc. Wherein, in the frame polarity inversion method, all liquid crystal capacitors in a frame are charged to a same voltage polarity while all liquid crystal capacitors in a next frame are charged to another same voltage polarity, such that the pictures displayed by the liquid crystal display panel with the frame polarity inversion method may generate flicker easily and has a poor visual effect because a gray scale difference exists between different polarities. Although the linear polarity inversion method and the point polarity inversion method may improve the above flicker phenomenon in varying degrees by using some voltage average effect, they have their own disadvantages, respectively: signals in a same voltage polarity direction may interfere with each other easily in the linear polarity inversion method, and the point polarity inversion method has a great power consumption.

Additionally, in some particular display modes, bias voltages among the respective sub-pixels can not be neutralized completely, such that a voltage at a common electrode may be pulled-up or pulled-down and voltage differences between the pixel electrodes in respective color sub-pixels and the common electrode increase or decrease, which may lead to a problem of color bias occurring in a display picture.

### SUMMARY

Embodiments of the present disclosure provide a liquid crystal display driving circuit, a driving method thereof and a liquid crystal display, which may balance polarities of voltages among respective sub-pixels on a liquid crystal display panel and improve flicker and color bias phenomenon.

In order to achieve the above objects, an aspect of the embodiments of the present disclosure provides a liquid crystal display driving circuit comprising a timing control circuit and at least two source driving circuits, further comprising a polarity inversion circuit; wherein the timing control circuit is connected with the polarity inversion circuit, and is configured to transmit a polarity inversion signal to the polarity inversion circuit; the polarity inversion circuit is connected with the timing control circuit and the at least two source driving circuits, respectively, and is configured to convert the polarity inversion signal into a first polarity inversion signal and a second polarity inversion signal to output the first polarity inversion signal and the second polarity inversion signal to the at least two source driving circuits, respectively, wherein a phase of the first polarity inversion signal is different from that of the second polarity inversion signal; the at least two source driving circuits comprise at least one first source driving circuit and at least one second source driving circuit, which are configured to receive the first polarity inversion signal and the second polarity inversion signal, respectively, so that voltages of source signals driven by the at least two source driving circuits have opposite polarities with each other.

Another aspect of the embodiments of the present disclosure provides a method for driving the liquid crystal display driving circuit provided by the present disclosure, comprising: transmitting, by the timing control circuit, the polarity inversion signal to the polarity inversion circuit; converting, by the polarity inversion circuit, the polarity inversion signal into the first polarity inversion signal and the second polarity inversion signal to output the first polarity inversion signal and the second polarity inversion signal to the at least two source driving circuits, respectively, wherein a phase of the first polarity inversion signal is different from that of the second polarity inversion signal; receiving, by the at least two source driving circuits comprising at least one first source driving circuit and at least one second source driving circuit, the first polarity inversion signal and the second polarity inversion signal, respectively, so that voltages of source signals driven by the at least two source driving circuits have opposite polarities with each other.

A still another aspect of the embodiments of the present disclosure provides a liquid crystal display comprising the liquid crystal display driving circuit provided by the embodiments of the present disclosure.

With the above solutions, the liquid crystal display driving circuit, the driving method thereof and the liquid crystal display provided by the embodiments of the present disclosure may provide two polarity inversion signals with different phases, and apply these two polarity inversion signals with different phases to different source driving circuits, respectively, thus, when a gate scanning is performed, data voltages having opposite polarities may generated by the different source driving circuits under the control of the two polarity inversion signals with different phases even for different sub-pixels which should have a same voltage polarity in a certain polarity inversion mode, which may further balance polarities of voltages among respective sub-pixels on a liquid crystal display panel and improve flicker and color bias phenomenon.

### BRIEF DESCRIPTION OF THE DRAWINGS

The present invention will become more fully understood from the detailed description given hereinafter and the accompanying drawings which are given by way of illustration only, and thus are not limitative of the present invention, other drawings may be obtained by those skilled in the art without creative labor being paid based on these accompanying drawings, wherein:

FIG. 1 is an exemplary diagram illustrating a structure of a liquid crystal display driving circuit provided by embodiments of the present disclosure;

FIG. 2 is an exemplary diagram illustrating a detailed structure of the liquid crystal display driving circuit provided by the embodiments of the present disclosure;

FIG. 3 is an exemplary diagram illustrating a detailed structure of an inverting unit in the liquid crystal display driving circuit provided by the embodiments of the present disclosure;

FIG. 4 is a partial exemplary diagram illustrating a polarity distribution of the data voltages of the sub-pixels on a liquid crystal display panel driven by the driving circuit shown in FIG. 2;

FIG. 5 is an exemplarity diagram illustrating a layout of the liquid crystal display driving circuit provided by the embodiments of the present disclosure;

FIG. 6 is a partial circuit diagram of the liquid crystal display driving circuit provided by the embodiments of the present disclosure;

FIG. 7 is an exemplary diagram illustrating a liquid crystal display panel driven by the liquid crystal display driving circuit provided by the embodiments of the present disclosure;

FIG. 8 is an exemplary diagram illustrating another detailed structure of the liquid crystal display driving circuit provided by the embodiments of the present disclosure;

FIG. 9 is a partial circuit diagram of the liquid crystal display driving circuit provided by the embodiments of the present disclosure; and

FIG. 10 is a flowchart illustrating a liquid crystal display driving method provided by the embodiments of the present disclosure.

### DETAILED DESCRIPTION

The technical solutions in embodiments of the present disclosure will be described clearly and completely below in connection with the accompanying drawings of the embodiments of the present disclosure. Obviously, the described embodiments are not all of embodiments of the present disclosure but only a part of embodiments of the present disclosure. With the teachings of the embodiments of the present disclosure, all of other embodiments obtained by those skilled in the art without paying creative labor should belong to the scope sought for protection in the present disclosure.

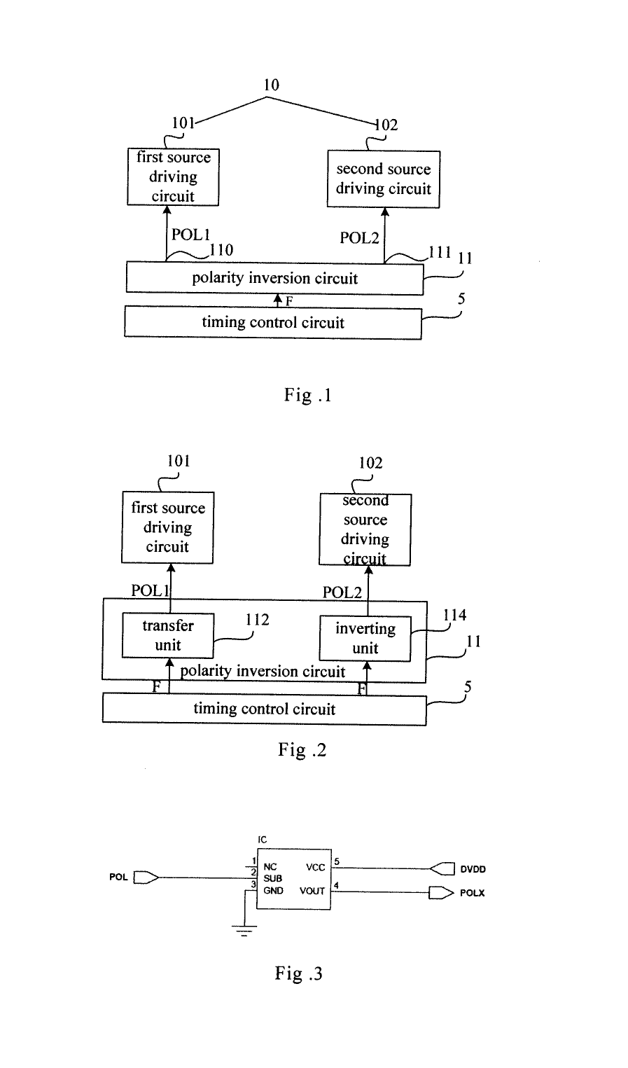

As illustrated in FIG. 1, the embodiments of the present disclosure provide a liquid crystal display driving circuit comprising a timing control circuit 5 and at least two source driving circuits 10, and further comprising a polarity inversion circuit 11; wherein the timing control circuit 5 is connected with the polarity inversion circuit 11, and is configured to transmit a polarity inversion signal F to the polarity inversion circuit 11.

The polarity inversion circuit 11 is connected with the timing control circuit 5 and the at least two source driving circuits 10, respectively, and is configured to convert the polarity inversion signal F into a first polarity inversion signal POL1 and a second polarity inversion signal POL2, so as to output the first polarity inversion signal POL1 and the second polarity inversion signal POL2 to the at least two source driving circuits 10, respectively, wherein a phase of the first polarity inversion signal POL1 is different from that of the second polarity inversion signal POL2.

The at least two source driving circuits 10 receive the first polarity inversion signal POL1 and the second polarity inversion signal POL2, respectively, so that voltages of source signals driven by the at least two source driving circuits 10 have opposite polarities with each other.

With the above solutions, the liquid crystal display driving circuit provided by the embodiments of the present disclosure may provide two polarity inversion signals POL1 and POL2 with different phases, and apply these two polarity inversion signals with different phases to the different source driving circuits 10, respectively, thus, when a gate scanning is performed, data voltages having opposite polarities may be generated by the different source driving circuits under the control of the two polarity inversion signals with different phases even for different sub-pixels which should have a same voltage polarity in a certain polarity inversion mode, which may further balance polarities of voltages among respective sub-pixels on a liquid crystal display panel and improve flicker and color bias phenomenon.

In particular, in this embodiment, the polarity inversion circuit 11 at least comprises a first output terminal 110 and a second output terminal 111, the first output terminal 110 is connected with the first source driving circuit 101 and outputs the first polarity inversion signal POL1 to the first source driving circuit 101; the second output terminal 111 is connected with the second source driving circuit 102 and outputs the second polarity inversion signal POL2 to the second source driving circuit 102. A polarity inversion signal F may be any kind of signals capable of performing a timing controlling on a circuit, for example a square wave, but the present disclosure is not limited thereto. The first polarity inversion signal POL1 is applied to the first source driving circuit 101 and enables polarities of data voltages of the first source driving circuit 101 to be inverted, while the second polarity inversion signal POL2 is applied to the second source driving circuit 102 and enables polarities of data voltages of the second source driving circuit 102 to be inverted.

Particularly, as illustrated in FIG. 2, in one embodiment of the present disclosure, the polarity inversion circuit 11 may comprise at least one transfer unit 112 and at least one inverting unit 114, wherein an input terminal of the transfer unit 112 is connected with the timing control circuit 5, and an outputting terminal of the transfer unit 112 is connected with the first source driving circuit 101; an input terminal of the inverting unit 114 is connected with the timing control circuit 5, and an output terminal of the inverting unit 114 is connected with the second source driving circuit 102.

The transfer unit 112 may be used to transfer the polarity inversion signal F output from the timing control circuit 5 to the first source driving circuit 101, and the polarity inversion signal F output from the timing control circuit 5 is the first polarity inversion signal POL1; the inverting unit 114 may be used to invert the polarity inversion signal F output from the timing control circuit 5 and then output the inverted signal to the second source driving circuit 102, and the inverted polarity inversion signal F is the second polarity inversion signal POL2. Thus, the first polarity inversion signal POL1 and the second polarity inversion signal POL2 are two signals having a same frequency, a same amplitude but with a phase difference of 180°.

Particularly, the transfer unit 112 and the inverting unit 114 could be various electrical elements, as long as the transfer unit 112 may normally output the polarity inversion signal F output from the timing control circuit 5 and the inverting unit 114 may inversely output the polarity inversion signal F output from the timing control circuit 5. For example, in the present embodiment, the transfer unit 112 may be a lead or a transfer gate, and the inverting unit 114 may be an inverter, and the like. Of course, the transfer unit 112 and the inverting unit 114 may be other forms in other embodiments of present disclosure, and the embodiments of the present disclosure are not limited thereto. For example, FIG. 3 illustrates a detailed example of the inverting unit, wherein the POL signal is inverted by a detailed integrated circuit (IC) chip. As illustrated in FIG. 3, a VCC terminal in the integrated circuit chip is connected with a power supply DVDD, a GND terminal is grounded, an idle pin NC terminal is floating, and an input terminal SUB receives the POL signal, then a signal POLX, which is inverted from the POL signal, may be output at an output terminal VOUT in the chip.

Optionally, in one embodiment of the present disclosure, when the liquid crystal display driving circuit has a plurality of first source driving circuits 101 and a plurality of second source driving circuits 102, each of the transfer unit 112 may be connected to one of the first source driving circuits 101 separately, or may be connected to the plurality of the first source driving circuits 101 at the same time, and so is connection between the inverting unit 114 and the second source driving circuits 102, the present disclosure is not limited thereto.

Particularly, in different polarity inversion modes within a liquid crystal display apparatus, such as a 1DOT or 2DOT inversion mode, the POL1 and POL2 (referred to as POL totally) change periodically as a periodical change in a gate scan signal. Particularly, level of the POL may be inverted whenever a scan signal comes (in a case of 1DOT), and also may be inverted when every two (in a case of 2DOT) or every several scan signals come, and the present disclosure is not limited thereto.

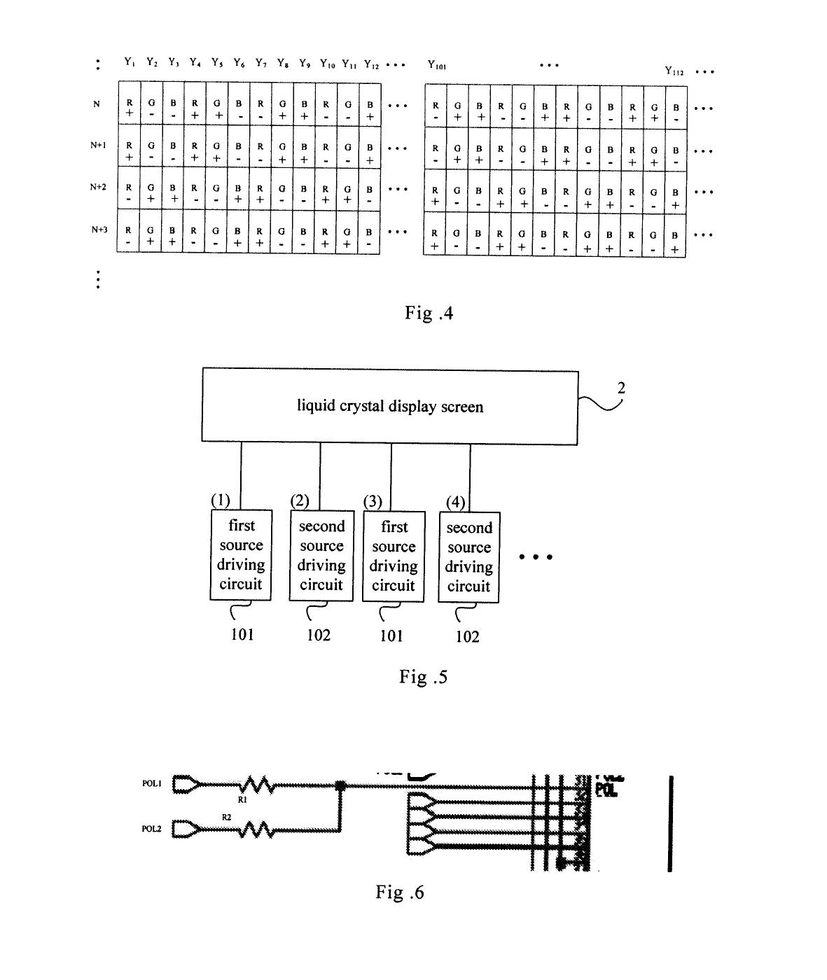

For example, in one embodiment of the present disclosure, FIG. 4 illustrates a partial exemplary view for a polarity distribution of the data voltages of the sub-pixels, under the 2DOT inversion mode, on a liquid crystal display panel driven by the driving circuit shown in FIG. 2. In FIG. 4, the first polarity inversion signal POL1 is provided to the first source driving circuit 101 in order to control a polarity inversion of data voltages of sub-pixels in columns Y₁-Y₁₂, and the second polarity inversion signal POL2 is provided to the second source driving circuit 102 in order to control a polarity inversion of data voltages of sub-pixels in columns Y₁₀₁-Y₁₁₂. R, G, B represent a red sub-pixel, a green sub-pixel and a blue sub-pixel, respectively.

Referring to FIGS. 2 and 4 collectively, when the gate scan signal scans the Nth row, that is, when the Nth row receives the scan signal, the source driving circuit 101 may determine the polarities of the data voltages of the respective sub-pixels in the Nth row, namely the polarities of the data voltages of the columns Y₁, Y₂, . . . , Y₁₂ in the Nth row, according to the level state of the POL1 signal and a datasheet of the source driving circuit 101, if the POL1 is at a high level. At the same time, the source driving circuit 102 may also determine the polarities of the data voltages of the respective sub-pixels in the Nth row, namely the polarities of the data voltages of the columns Y₁₀₁, Y₁₀₂, . . . , Y₁₁₂ in the Nth row, according to the level state of the POL2 signal and a datasheet of the source driving circuit 102. At this time, because the POL1 is at the high level and the POL2 is at a low level, the source driving circuits 101 and 102 control the polarities of the data voltages on the sub-pixels controlled by the source driving circuit 101 and the polarities of the data voltages on the sub-pixels controlled by the source driving circuit 102 to be different correspondingly. For example, the data voltage of a red sub-pixel on column Y₁ of a Nth row is positive (+), and the data voltage of a red sub-pixel on column Y₁₀₁ of the Nth row is negative (−). At a next time, when the gate scan signal scans a (N+1)th row, that is, when the (N+1)th row receives the scan signal, neither the POL1 signal nor the POL2 signal inverts, therefore the polarities of the data voltages of the sub-pixels in the (N+1)th row are same as those in the Nth row. At a further next time, that is, when a (N+2)th row receives the scan signal, the POL1 inverts to the low level and the POL2 inverts to the high level, thus the source driving circuits 101 and 102 may determine the polarities of the data voltages of the respective sub-pixels in the (N+2)th row according to the level states of the POL1 signal and the POL2 signal and the datasheets of the source driving circuits.

It can be seen that changes in the polarities of the data voltages on the sub-pixels controlled by the source driving circuits 101 and 102, respectively, are opposite within an operation period of a same scan signal, such as the time when the scan signal scans the Nth row, by applying the POL1 and the POL2 to the different source driving circuits 101 and 102, respectively. In the same way, when the scan signal scans the (N+1)th, (N+2)th, or (N+3)th row, the inversion status of the polarities of the data voltage on the respective sub-pixels is similar to the Nth row, which may further balance polarities of voltages among respective sub-pixels on the liquid crystal display panel and improve flicker and color bias phenomenon.

As illustrated in FIG. 5, in order to enable the polarities of the voltages among the respective sub-pixels be balanced efficiently, in one embodiment of the present disclosure, a plurality of first source driving circuit 101 and a plurality of second source driving circuit 102 are spaced with each other and arranged below a liquid crystal display screen 2 sequentially. Wherein the first source driving circuits 101 are the source driving circuits numbered as odd number (1), (3), . . . , and the second source driving circuits 102 are the source driving circuits numbered as even number (2), (4), . . . ; of course, vice versa in other embodiments of the present disclosure, for example, the first source driving circuits 101 may also be the source driving circuits numbered as the even number and the second source driving circuits 102 may also be the source driving circuits numbered as the odd number, or the first source driving circuits 101 and the second source driving circuits 102 may correspond to other distribution manners, as long as it may balance polarities of voltages among respective sub-pixels on the liquid crystal display panel and improve the flicker and color bias phenomenon, and the present disclosure is not limited thereto.

In particularly, the ways for providing the first polarity inversion signal POL1 and the second polarity inversion signal POL2 to the source driving circuits may be various, and the present disclosure is not limited thereto. For example, as illustrated in FIG. 6, in one embodiment of the present disclosure, the POL1 and the POL2 may be connected with a POL terminal in a source driving circuit via variable resistors R1 and R2, respectively. When the number of the source driving circuit is an odd number, the POL1 may be input to the POL terminal of the source driving circuit with the odd number by adjusting values of the resistors, for example, the value of R1 is equal to 0 (corresponding to a short circuit) and the value of R2 is equal to an infinity (corresponding to an open circuit). Also, when the number of the source driving circuit is an even number, the POL2 may be input to the POL terminal of the source driving circuit with the even number by adjusting values of the resistors, for example, the value of R1 is equal to the infinity (corresponding to the open circuit) and the value of R2 is equal to 0 (corresponding to the short circuit). Wherein the source driving circuit with an odd number and the source driving circuit with an even number are arranged on one side of the liquid crystal display panel alternately.

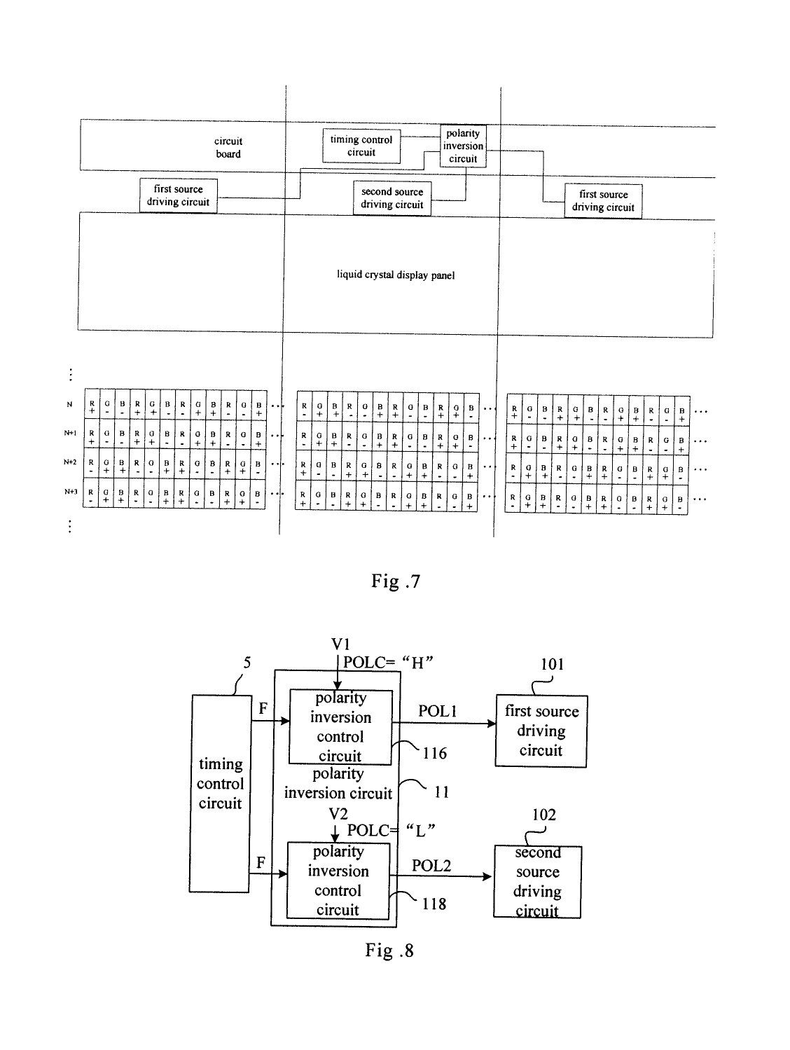

It should note that, although the first and second source driving circuits control pixels of several adjacent columns, respectively, in the above embodiments, the present disclosure is not limited thereto, and the pixels controlled by the first source driving circuit 101 and the second source driving circuit 102 may be any number and distributed on the liquid crystal display panel in any shape and any manner. For example, as illustrated in FIG. 7, in another embodiment of the present disclosure, the liquid crystal display panel is driven by two first source driving circuits 101 and one second source driving circuit 102 commonly, and its detailed operation process is similar to that of the embodiment illustrated in FIG. 4, and details are omitted herein.

Furthermore, although the polarity inversion circuit 11 in the above embodiment is consisted of the transfer unit 112 and the inverting unit 114, the present disclosure is not limited thereto. In other embodiments of the present disclosure, the polarity inversion circuit 11 may have other circuit structures.

For example, as illustrated in FIG. 8, in one embodiment of the present disclosure, a polarity inversion circuit 11 may comprise at least two polarity inversion control circuits, wherein an input terminal of a first polarity inversion control circuit 116 is connected with a timing control circuit 5, its output terminal is connected with the first source driving circuit 101, its control terminal is connected with a first control signal V1, and the first polarity inversion control circuit 116 is used to directly output a polarity inversion signal F as a first polarity inversion signal POL1 according to the first control signal V1; an input terminal of a second polarity inversion control circuit 118 is connected with the timing control circuit 5, its output terminal is connected with the second source driving circuit 102, its control terminal is connected with a second control signal V2, and the second polarity inversion control circuit 118 is used to invert the polarity inversion signal F and then output the inverted signal as a second polarity inversion signal POL2 according to the second control signal V2; the first control signal V1 is different from the second control signal V2. Optionally, in one embodiment of the present disclosure, the first control signal V1 and the second control signal V2 may be obtained by adjusting divider resistors in the circuit, respectively.

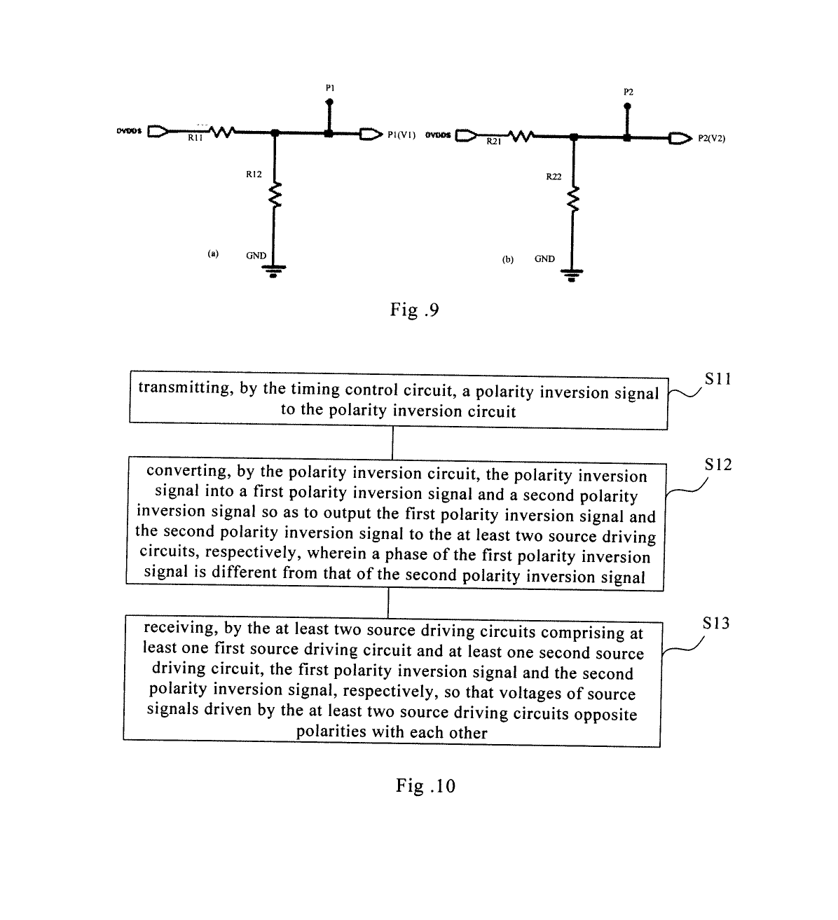

For example, in one embodiment of the present disclosure, the V1 and V2 may be obtained by circuits illustrated in FIG. 9. As illustrated in FIG. 9, in (a), a power supply voltage DVDDS is connected with a port P1 via a resistor R11, a ground GND is connected with the port P1 via a resistor R12, and an output voltage at P1 is V1. When the R11 is 0 and the R12 is infinity, the port P1 may output V1=“H”. In (b), a power supply voltage DVDDS is connected with a port P2 via a resistor R21, a ground GND is connected with the port P2 via a resistor R22, and an output voltage at P2 is V2. When the R21 is 0 and the R22 is infinity, the port P2 may output V2=“L”.

In particular, the polarity inversion control circuit 116 may directly output the polarity inversion signal F output from the timing control circuit 5 to the first source driving circuit 101 according to a control signal POLC input to the polarity inversion control circuit 116; and the polarity inversion control circuit 118 may invert the polarity inversion signal F output from the timing control circuit 5 and then output the inverted signal to the second source driving circuit 102 according to a control signal POLC input to the polarity inversion control circuit 118; wherein the polarity inversion signal F output directly is the first polarity inversion signal POL1, and the inverted signal output after the polarity inversion signal F being inverted is the second polarity inversion signal POL2. Thus the polarity inversion signal output from the timing control circuit 5 may be controlled to be output directly or output after being inverted through the polarity inversion control circuit 116 or 118 only by controlling the level of the POLC. In the present embodiment, the polarity inversion control circuit 116 directly outputs the polarity inversion signal F output from the timing control circuit 5 to the first source driving circuit 101 as the POL1, when the POLC=“H”, namely the POLC is at the high level, while the polarity inversion control circuit 118 inverts the polarity inversion signal F output from the timing control circuit 5 and outputs the inverted signal to the second source driving circuit 102 as the POL2, when the POLC=“L”, namely the POLC is at the low level. Of course, vice versa, and whether the high level or low level of the POLC leads to the inverted output of the polarity inversion circuit 11 is decided by a detailed circuit structure. Structures of the polarity inversion control circuit 116 and the polarity inversion control circuit 118 may be same or not, as long as they can realize the above functions, and the present disclosure is not limited thereto.

Optionally, the polarity inversion circuit 11 may have a circuit structure disposed on a chip directly and may provide two polarity inversion signals with different phases at the same time. For example, in one embodiment of the present disclosure, the polarity inversion circuit 11 may be integrated into a timing control chip, and the first polarity inversion signal and the second polarity inversion signal may be two square wave sequences having a phase difference of 180° in the timing control chip.

Corresponding to the above driving circuit of the liquid crystal display, the embodiments of the present disclosure further provide a driving method for the above liquid crystal display driving circuit, and as illustrated in FIG. 10, it comprises steps as follows:

S11, transmitting, by the timing control circuit, the polarity inversion signal to the polarity inversion circuit;

S12, converting, by the polarity inversion circuit, the polarity inversion signal into the first polarity inversion signal and the second polarity inversion signal which are output to the at least two source driving circuits, respectively, wherein a phase of the first polarity inversion signal is different from that of the second polarity inversion signal;

S13, receiving, by the at least two source driving circuits, the first polarity inversion signal and the second polarity inversion signal, respectively, so that voltages of source signals driven by the at least two source driving circuits have opposite polarities with each other.

With the above solutions, the liquid crystal display driving circuit, the driving method thereof and the liquid crystal display provided by the embodiments of the present disclosure may provide two polarity inversion signals with different phases, and apply these two polarity inversion signals with different phases to different source driving circuits, respectively, thus, when a gate scanning is performed, data voltages having opposite polarities may be generated by the different source driving circuits under the control of the two polarity inversion signals with different phases even for different sub-pixels which should have same voltage polarities in a certain polarity inversion mode, which may further balance polarities of voltages among respective sub-pixels on a liquid crystal display panel and improve flicker and color bias phenomenon.

In particularly, in the step S12, the polarity inversion signal output from the timing control circuit may be output in two paths, wherein the polarity inversion signal is output directly as the first polarity inversion signal in one path, and the polarity inversion signal is inverted and the inverted signal is output as the second polarity inversion signal in the other path.

Optionally, the polarity inversion signal may be output as the first polarity inversion signal through leads or transfer gates in one path, and the polarity inversion signal may be inverted by an inverter and the inverted signal is output as the second polarity inversion signal in the other path.

Further, in the step S12, the first polarity inversion signal and the second polarity inversion signal POL may be provided by a timing control chip.

Correspondingly, the embodiments of the present disclosure further provide a liquid crystal display comprising the liquid crystal display driving circuit provided by the embodiments of the present disclosure, therefore it may also achieve the benefit effects achieved by the liquid crystal display driving circuit. Detailed descriptions have been stated previously, and details are omitted accordingly.

Those skilled in the art can understand that all or part of process achieving the above process embodiments may be embodied by a configuration of hardware related to computer program instructions and peripheral circuits related to the hardware. The above-described program may be stored in a computer readable storage medium and perform steps of the above method embodiments as being executed. The storage medium may be any medium capable storing the program codes, such as a U disk, a movable hardware, a Read-Only memory (ROM), a Random Access Memory (RAM), a diskette, an optical disk and the like.

The above descriptions only illustrate the specific embodiments of the present invention, and the protection scope of the present invention is not limited to this. Given the teaching as disclosed herein, variations or substitutions, which can easily occur to any skilled pertaining to the art, should be covered by the protection scope of the present invention. Thus, the protection scope of the present invention is defined by the claims.

What is claimed is:

1. A liquid crystal display driving circuit comprising a timing control circuit and at least two source driving circuits, further comprising a polarity inversion circuit; wherein,
the timing control circuit is connected with the polarity inversion circuit, and is configured to transmit a polarity inversion signal to the polarity inversion circuit;
the polarity inversion circuit is connected with the timing control circuit and the at least two source driving circuits, respectively, and is configured to convert the polarity inversion signal into a first polarity inversion signal and a second polarity inversion signal which are output to the at least two source driving circuits, respectively, wherein a phase of the first polarity inversion signal is different from that of the second polarity inversion signal;
the at least two source driving circuits comprise at least one first source driving circuit and at least one second source driving circuit, which are configured to receive the first polarity inversion signal and the second polarity inversion signal, respectively, so that voltages of source signals driven by the at least two source driving circuits have opposite polarities with each other.

2. The circuit of claim 1, wherein the polarity inversion circuit comprises at least one transfer unit and at least one inverting unit, an input terminal of the transfer unit is connected with the timing control circuit, and an outputting terminal of the transfer unit is connected with the first source driving circuit; an input terminal of the inverting unit is connected with the timing control circuit, and an output terminal of the inverting unit is connected with the second source driving circuit, the first polarity inversion signal and the second polarity inversion signal are two signals having a same frequency, a same amplitude but with a phase difference of 180°.

3. The circuit of claim 2, wherein the transfer unit is a lead or a transfer gate, and the inverting unit is an inverter.

4. The circuit of claim 1, wherein the polarity inversion circuit comprises at least two polarity inversion control circuits, wherein an input terminal of a first polarity inversion control circuit is connected with the timing control circuit, an output terminal thereof is connected with the first source driving circuit, a control terminal thereof is connected with a first control signal, and the first polarity inversion control circuit is used to directly output the polarity inversion signal as a first polarity inversion signal according to the first control signal; an input terminal of a second polarity inversion control circuit is connected with the timing control circuit, an output terminal thereof is connected with the second source driving circuit, a control terminal thereof is connected with a second control signal, and the second polarity inversion control circuit is used to invert the polarity inversion signal and then output the inverted signal as a second polarity inversion signal according to the second control signal; the first control signal is different from the second control signal.

5. The circuit of claim 4, wherein the polarity inversion circuit is integrated into a timing control chip.

6. The circuit of claim 1, wherein the first source driving circuit is adjacent to the second source driving circuit.

7. A method for driving the liquid crystal display driving circuit of claim 1, comprising:
transmitting, by the timing control circuit, the polarity inversion signal to the polarity inversion circuit;
converting, by the polarity inversion circuit, the polarity inversion signal into the first polarity inversion signal and the second polarity inversion signal so as to output the first polarity inversion signal and the second polarity inversion signal to the at least two source driving circuits, respectively, wherein a phase of the first polarity inversion signal is different from that of the second polarity inversion signal;
receiving, by the at least two source driving circuits comprising at least one first source driving circuit and at least one second source driving circuit, the first polarity inversion signal and the second polarity inversion signal, respectively, so that voltages of source signals driven by the at least two source driving circuits have opposite polarities with each other.

8. The method of claim 7, wherein the step of converting, by the polarity inversion circuit, the polarity inversion signal into the first polarity inversion signal and the second polarity inversion signal so as to output the first polarity inversion signal and the second polarity inversion signal to the at least two source driving circuits, respectively, further comprising:
outputting the polarity inversion signal output from the timing control circuit in two paths, wherein outputting the polarity inversion signal directly as the first polarity inversion signal in one path, and inverting the polarity inversion signal and outputting the inverted signal as the second polarity inversion signal in the other path, the first polarity inversion signal and the second polarity inversion signal are two signals having a same frequency, a same amplitude but with a phase difference of 180°.

9. The method of claim 8, wherein the step of outputting the polarity inversion signal directly as the first polarity inversion signal in one path and inverting the polarity inversion signal and outputting the inverted signal as the second polarity inversion signal in the other path further comprising:
outputting the first polarity inversion signal as the first polarity inversion signal through leads or transfer gates in the one path, and inverting the polarity inversion signal by an inverter and outputting the inverted signal as the second polarity inversion signal in the other path.

10. The method of claim 7, wherein the step of converting, by the polarity inversion circuit, the polarity inversion signal into the first polarity inversion signal and the second polarity inversion signal so as to output the first polarity inversion signal and the second polarity inversion signal to the at least two source driving circuits, respectively, further comprising:
providing the first polarity inversion signal and the second polarity inversion signal by a timing control chip.

11. A liquid crystal display comprising a liquid crystal display driving circuit, the liquid crystal display driving circuit comprises a timing control circuit, at least two source driving circuits and a polarity inversion circuit, wherein:
the timing control circuit is connected with the polarity inversion circuit, and is configured to transmit a polarity inversion signal to the polarity inversion circuit;
the polarity inversion circuit is connected with the timing control circuit and the at least two source driving circuits, respectively, and is configured to convert the polarity inversion signal into a first polarity inversion signal and a second polarity inversion signal so as to output the first polarity inversion signal and the second polarity inversion signal to the at least two source driving circuits, respectively, wherein a phase of the first polarity inversion signal is different from that of the second polarity inversion signal;
the at least two source driving circuits comprise at least one first source driving circuit and at least one second source driving circuit, which are configured to receive the first polarity inversion signal and the second polarity inversion signal, respectively, so that voltages of source signals driven by the at least two source driving circuits have opposite polarities with each other.

12. The liquid crystal display of claim 11, wherein the polarity inversion circuit comprises at least one transfer unit and at least one inverting unit, an input terminal of the transfer unit is connected with the timing control circuit, and an outputting terminal of the transfer unit is connected with the first source driving circuit; an input terminal of the inverting unit is connected with the timing control circuit, and an output terminal of the inverting unit is connected with the second source driving circuit, the first polarity inversion signal and the second polarity inversion signal are two signals having a same frequency, a same amplitude but with a phase difference of 180°.

13. The liquid crystal display of claim 11, wherein the polarity inversion circuit comprises at least two polarity inversion control circuits, wherein an input terminal of a first polarity inversion control circuit is connected with the timing control circuit, an output terminal thereof is connected with the first source driving circuit, a control terminal thereof is connected with a first control signal, and the first polarity inversion control circuit is used to directly output the polarity inversion signal as a first polarity inversion signal according to the first control signal; an input terminal of a second polarity inversion control circuit is connected with the timing control circuit, an output terminal thereof is connected with the second source driving circuit, a control terminal thereof is connected with a second control signal, and the second polarity inversion control circuit is used to invert the polarity inversion signal and then output the inverted signal as a second polarity inversion signal according to the second control signal; the first control signal is different from the second control signal.

14. The liquid crystal display of claim 13, wherein the polarity inversion circuit is integrated into a timing control chip.

15. The liquid crystal display of claim 11, wherein the first source driving circuit is adjacent to the second source driving circuit.
